(19) United States
(12) Patent Application Publication
(10) Pub. No.: US 2009/0291384 A1
(43) Pub. Date: Nov. 26, 2009

(54) METHOD OF MANUFACTURING TONER, APPARATUS OF MANUFACTURING A TONER, A TONER, AN IMAGE FORMING METHOD AND AN IMAGE FORMING APPARATUS

(76) Inventor: Hiroshi TAKAHASHI, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/468,893

(22) Filed: May 20, 2009

(30) Foreign Application Priority Data
May 20, 2008 (JP) 2008-132079

(51) Int. Cl. G03G 9/087; G03G 9/09; G03G 9/08; G03G 13/20; G03G 15/08; G05D 11/02

(52) U.S. Cl. 430/110.4; 430/137.1; 430/110.1; 430/124.1; 399/252; 366/142

(57) ABSTRACT

A method of manufacturing a toner including a first dispersing wherein (i) at least two binder resins having different weight average molecular weight, (ii) a coloring agent and (iii) a releasing agent are dispersed in an organic solvent to obtain an oil phase, a second dispersing comprising continuously mixing the oil phase with an aqueous medium comprising a solid particulate dispersion agent to form a dispersion emulsion comprising emulsification particles (where at least one of the first and the second dispersing is carried out under at least one condition based on a property of the binder resin which has the lowest weight-average molecular weight), measuring automatically the volume average particle diameter of the dispersion emulsion during the second dispersing, calculating automatically a difference between the volume average particle diameter of the dispersion emulsion measured during the measuring and a target volume average particle diameter, maintaining automatically an allowable difference between the volume average particle diameter of the dispersion emulsion measured during the measuring and the target volume average particle diameter by changing one of the conditions.

### BACKGROUND OF THE INVENTION

1. Field of the Invention

The present invention relates to a method of manufacturing a toner, an apparatus for manufacturing a toner, a toner, an image forming method and an image forming apparatus.

2. Discussion of the Background

In a developing step, a developer used in electrophotography, electrostatic recording, electrostatic printing or the like, is firstly adhered to an image-bearing member such as a photoconductor on which a latent electrostatic image is formed. In a transferring step, the developer is then transferred from the photoconductor to a transferring medium such as a transfer paper, and is then fixed in an image-fixing step. In this procedure, the developer for developing an electrostatic image formed on the image-bearing surface of the transfer paper, may be a two-component developer comprising a carrier and a toner, or a single-component developer (magnetic toner/non-magnetic toner) which does not need a carrier.

Conventionally, dry toners used for electrophotography, electrostatic recording and electrostatic printing, are obtained by melt kneading a binder resin such as a styrene resin or a polyester resin with a coloring agent, and then pulverizing.

In order to obtain high image quality and high appearance quality, improvement has been made by making the particle diameter small, but with the usual manufacturing process of kneading and pulverizing, the particle formation is not defined and is not spherical. Inside the apparatus, the toner is stirred with the carrier in the developing part. In the case of a single-component developer, toner is further pulverized by shear with a development roller, a toner supplying roller, a blade for adjusting a thickness of toner layer and the frictional charge blade. This process produces submicron particles and fluidizers are embedded on the toner surface. In that case, an image quality is deteriorated. Also, due to the formation of toner, flowability of toner as powder is not enough, therefore the toner is required to have more fluidized, or there is a necessity to have low filling rate of toner in its toner bottle. So it is difficult to make the apparatus smaller. Therefore a merit of a toner having a small particle diameter isn't gained enough. In addition, there is a limit of toner particle diameter to make smaller.

To make up some problems that occur when a shape of toner particle is not defined, various kinds of spherical toner manufacturing processes are devised. One of known method is a suspension polymerization method. In the suspension polymerization method, there is an emulsification process that an oil phase is emulsified to the particle diameter of toner in an aqueous phase by giving a mechanical force for emulsification. In the oil phase, toner components including a binder resin, a coloring agent and a releasing agent in an organic solvent are dispersed or dissolved. In the process, a solid particulate dispersion agent is included in an aqueous phase as a stabilizer of emulsified droplets, small minute droplets that have a small particle distribution (Dv/Dn) can be obtained.

In the present invention, a toner compares particle having a spherical particle shape a ratio (Dv/Dn) of a volume average particle diameter (Dv) to a number average particle diameter (Dn) of from 1.05 to 1.25 so that good quality of image forming can be provided.

As a method of producing emulsified droplets, the most preferable condition for the beginning of emulsification depending on the property of toner components may be adjusted. In addition, a condition of emulsification process depending on a particle diameter measured during the process may be instantly adjusted so that the toner having a targeted particle diameter is provided. Conventionally, emulsification process were emulsifying, sampling the emulsification dispersions and measuring the particle diameter in a different place from emulsification manufacturing. When the measured particle diameter is out of the range be targeted, condition for manufacturing is adjusted every time. With this manufacturing process, it takes time for particle diameters appropriately adjusted and an artificial mistake may be occurred.

For solving these problems, following ideas are suggested.

The unexamined published Japanese patent application No. (hereinafter referred to as JOP) 2000-117095 describes that in production of a microcapsule used for a pressure sensitive copying paper, medical supplies, a pesticide, glue, liquid crystal and a pigment capsule, degree of emulsification dispersion (particle diameter of a grease spot scattered for emulsification) depends on valid shear stress added during emulsification dispersion process, thus, it depends on liquid viscosity according to a liquid temperature, in addition, it depends on flow quantity. Hydrophobic liquid particle diameter scattered for emulsification is measured automatically, and based on data of relation between an emulsification temperature or flow quantity and data of an average particle diameter inputted into a computer beforehand. A method for manufacturing a microcapsule that the hydrophobic liquid particle diameter scattered for emulsification is adjusted to targeted diameter by automatically controlling the emulsification temperature or flow quantity.

In the published Japanese patent application, emulsification temperature and flow quantity can be adjusted so that the particle diameter can be instantly adjusted. Not only the particle diameter is instantly adjusted, providing a line for sampling a product depending on a data of particle diameter, from measuring a particle diameter to control a particle diameter, sampling of product is automatically provided so that a work load of the person in charged with producing is reduced as well as unmanned manufacturing factory can be provided.

JOP 2006-299219 describes that a method of manufacturing a emulsification particle by emulsifying an oil phase and an aqueous phase which has a particle diameter from 3 to 10 μm. The method includes a measuring process of an emulsification particle diameter, calculating process of the particle diameter's change measured by the measuring process, and controlling process of the condition for stirring of emulsification machine. The calculating process includes at least one of emulsification particle diameter (Dv), quantity of change of emulsification particle diameter Dv (ΔDv), prediction convergence value of emulsification particle diameter (Dv ∞), and during the controlling process the particle diameter of emulsification particles is controlled by making fluctuate the number of revolutions of emulsification machine.

In the published Japanese patent application, the emulsification particles under manufacturing is controlled, but setting of a process condition at the time of a production start and sampling of product depending on emulsification particle diameter are not included.

### SUMMARY OF THE INVENTION

Because of these reasons, the present inventors recognize that a need exists for a method of stably and efficiently manufacturing a toner which has a stable volume average particle diameter and a toner which has a uniform particle diameter with a sharp particle diameter distribution to obtain good quality in full color images according to a latent image picture.

According to the process of the present invention, a condition of emulsification process for beginning is presumed by a property of a composition of toner. And emulsification particles of emulsification dispersions are automatically adjusted depending on a data inputted into a computer beforehand, so stable quality of toner is provided with high yield.

According to the present invention, technologies disclosed in JOP 2006-299219 incorporated herein by reference in its entirely. In the reference, the emulsification particles under manufacturing is controlled, but setting of at least one condition based on property of the binder resin and dividing of product depending on emulsification particle diameter are not included.

In the present invention, a volume average particle diameter of emulsification dispersions is automatically measured, particle diameter is instantly controlled depending on relations between a volume average particle diameter inputted into a computer beforehand and control factors for emulsification. In addition, having a product sampling line depending on volume average particle diameter, a toner that has a uniform composition, targeted volume average particle diameter and a sharp particle diameter can be provided quickly and precisely during an emulsification process. Briefly this object and other objects of the present invention as hereinafter described will become more readily apparent and can be attained, either individually or in combination thereof, by a method of manufacturing a toner comprising,

a first dispersing wherein (i) at least two binder resins having different weight average molecular weight, (ii) a coloring agent and (iii) a releasing agent are dispersed in an organic solvent to obtain an oil phase,

a second dispersing comprising continuously mixing the oil phase with an aqueous medium comprising a solid particulate dispersion agent to form a dispersion emulsion comprising emulsification particles,

wherein the at least one of the first and the second dispersing is carried out under at least one condition based on a property of the binder resin which has the lowest weight-average molecular weight,

measuring automatically the volume average particle diameter of the dispersion emulsion during the second dispersing,

calculating automatically a difference between the volume average particle diameter of the dispersion emulsion measured during the measuring, and a target volume average particle diameter,

maintaining automatically an allowable difference between the volume average particle diameter of the dispersion emulsion measured during the measuring, and a target volume average particle diameter, by changing one of the conditions.

“Automatically” means that the processes are proceeded according to directions from a computer for measuring, calculating and maintaining. In other words, it's not necessary to be given directions for measuring, calculating and maintaining by human workers during manufacturing process in the present invention.

The allowable difference between the volume average particle diameter of the dispersion emulsion measured during the measuring, and a target volume average particle diameter may be within −0.5 to 0.5 μm range, preferably within −0.3 to 0.3 μm range. It is preferred that the controlling occur when the difference of targeted particle diameter and measured particle diameter is out of the range.

It is preferred that, in the method of manufacturing a toner mentioned above, at least one of the property of the binder resin which has the lowest weight-average molecular weight among the resins for toner is selected from the group comprising of the glass transition temperature (Tg) of the resin, the weight-average molecular weight of the resin, the acid value of the resin and the half efflux temperature of the resin.

It is still further preferred that the method mentioned above, at least one of the condition is selected from the group comprising of a circumferential speed of a emulsification machine, a ratio of the oil phase and the aqueous phase (O/W ratio) and a total amount of the oil phase as well as the aqueous phase.

It is still further preferred that, in the method mentioned above, collecting the emulsification particles that are within −0.5 to 0.5 μm range, preferably within −0.3 to 0.3 μm range of the target particle diameter. It is preferred that the controlling occur when the difference of targeted particle diameter and measured particle diameter is out of the range.

Another illustrative embodiment provides an apparatus of manufacturing a toner, comprising,

an emulsifying facility for continuously emulsifying a dispersion of at least two binder resins having different weight-average molecular weight, a coloring agent and a releasing agent in an organic solvent (oil phase) in an aqueous medium includes a solid particulate dispersion agent,

wherein the emulsifying facility comprising a means for dispersing under a condition based on at least one property of the binder resin which has the lowest weight-average molecular weight,

a means for automatically measuring the volume particle diameter of the dispersion emulsion during the dispersing,

a means for calculating a difference between the volume average particle diameter of the dispersion emulsion measured during the measuring, and a target volume average particle diameter,

a means for receiving a signal for controlling the process of manufacturing,

wherein the signal is calculated from a relation between the information about the difference between the volume average particle diameter of the dispersion emulsion measured during the measuring, and a target volume average particle diameter calculated by the means for calculating and a difference between a volume average particle diameter of a dispersion emulsion measured during the measuring, and a target volume average particle diameter as well as a condition for process inputted in the computer beforehand,

a means for automatically controlling the process of manufacturing,

a means for collecting the emulsification particles that satisfy the required volume average particle diameter.

Another illustrative embodiment provides a toner has a volume average particle diameter is from 3 to 10 μm, preferably from 3 to 7 μm, more preferably from 4 to 6.5 manufactured by the methods mentioned above. The toner may be preferably used in an apparatus mentioned above.

It is still further preferred that the toner mentioned above, the toner has a ratio (Dv/Dn) of a volume average particle diameter (Dv) to a number average particle diameter (Dn) from 1.05 to 1.25, preferably from 1.05 to 1.15.

Another illustrative embodiment provides an image forming method comprising,

forming a latent image on an image bearing member,

developing the latent image with a developer comprising the toner mentioned above to form a toner image,

transferring the toner image onto a transfer material, and

fixing the toner image on the transfer material upon application of heat.

Another illustrative embodiment provides an image forming apparatus comprising,

an image bearing member bearing an electrostatic latent image,

an image developer developing the latent image with a developer comprising the toner mentioned above to form a toner image on the image bearing member, and

a container containing the developer.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a figure showing an example of a continuous emulsification process.

FIG. 2 is a diagram illustrating a cross section of an example of an image forming apparatus; and

FIG. 3 is a diagram illustrating an enlarged portion of the image forming apparatus of FIG. 2.

### DETAILED DESCRIPTION OF THE INVENTION

According to the method of the present invention, as production process is stabilized, product yield and quality improve. In addition, as the number of process for manufacturing can be reduced, cost for production can be reduced. As a result, a toner develops faithfully in a latent image, so high-resolution full color image can be reproduced, and a method for manufacturing a toner can be provided.

The present invention is explained in detail as follows.

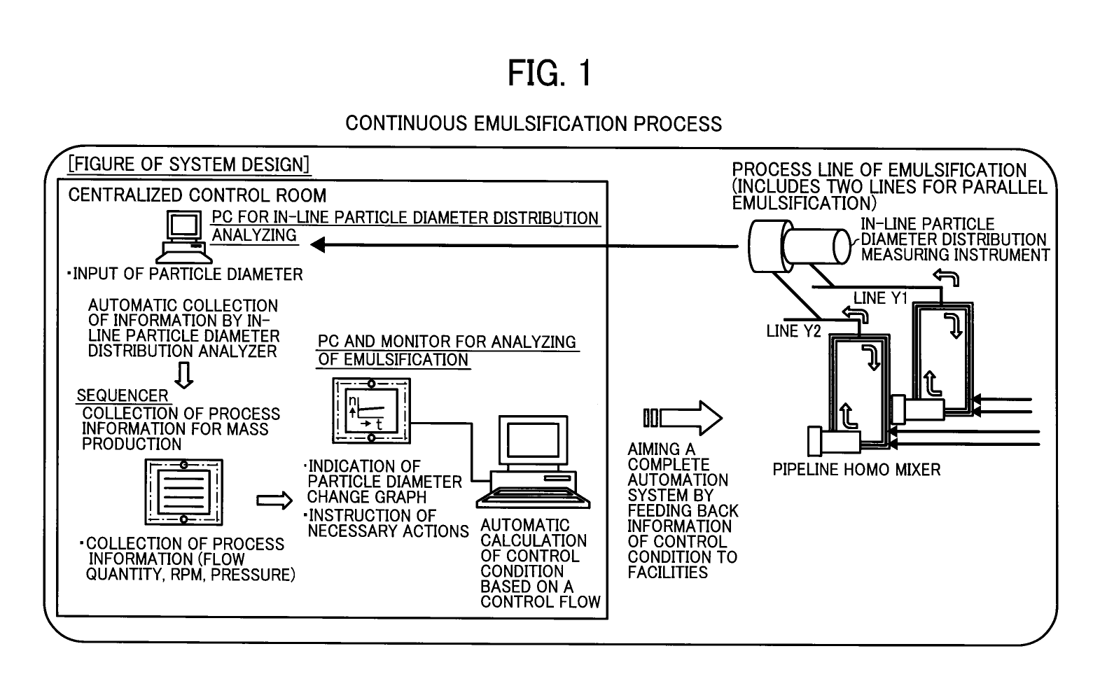

FIG. 1 is a figure showing an example of a continuous emulsification process of the present invention. In the example shown in FIG. 1, Y1 and Y2 are examples of an O/W liquid including an oil phase A and an O/W liquid including an oil phase B. In other words, FIG. 1 is an example of transport line for a liquid solution or a dispersion of toner material compositions that includes at least two binder resins having different weight-average molecular weight, a coloring agent, a release agent dissolved or dispersed in an organic solvent (oil phase). An in-line particle diameter distribution meter (PC) and a monitor using for monitoring of emulsification (2ndPC) in FIG. 1 function interactively for determining the most suitable condition for the beginning of manufacturing process depending on properties of materials using for toner including a binder resin, for calculating difference between the volume average particle diameter of the dispersion emulsion measured during dispersing and a target volume average particle diameter, for controlling facilities automatically by changing one of the conditions for manufacturing, for collecting product using collecting line or for separating the collecting line automatically. After the most suitable condition for the beginning of manufacturing process is determined, a sequencer changes (switches) to “negative feedback control” for getting rid of the difference (deviation value) between a measured value and the most suitable condition for the beginning of manufacturing process. A timing of the changing depends on a value range of sampling period (τ) of following PID digital control algorithm, for example.

ΔMₙ=K{Δeₙ+(τ/T₁)Σeₙ+(T_{D}/τ)Δ²eₙ}, ΔMₙ is output value, K is P gain (=100/P), T₁ is an integral calculus control unit, T_{D} is a differential calculus control unit, eₙ is a difference between target value and measured value (target value−measured value).

In the following examples, difference between the volume average particle diameter of the dispersion emulsion measured during dispersing and a target volume average particle diameter is calculated using 2ndPC from a value of particle diameter measured by an in-line particle diameter distribution meter. In addition, based on a measured particle diameter, a line for collecting product is kept automatically. Ordering for manufacturing process is calculated by 2ndPC and displayed on a monitor of 2ndPC. A link to facilities is done using a sequencer. In continuous production, the data which 20 lots dated back to are used, for example (calculated by T method or MT method). On a process for controlling, the data is fed back to controlling a turbine wing of an emulsifier and frequencies of pumps of oil phase A/ oil phase B as well as aqueous phase.

In this exampled process, a liquid solution or a dispersion of toner material compositions that includes at least two binder resins having different weight-average molecular weight, a coloring agent, a release agent dissolved or dispersed in an organic solvent with an extension agent (an oil phase A) and an aqueous phase includes a solid particulate dispersion agent in aqueous device as well as a prepolymer includes isocyanate group (an oil phase B) are sent with a certain fixed quantity continually, an oil phase A and an oil phase B are pre-stirred with a static mixer (STM) beforehand mixing the oil phase A, the oil phase B with aqueous phase. The liquid after pre-stirred is an oil phase. Mixture of an oil phase and an aqueous phase using STM receiving a shear and emulsified (getting emulsified liquid) in an emulsification mechanism part with a stay capacity of a pipeline homo mixer (PLHM).

As mentioned above, by deciding a condition for a beginning of manufacturing process depending on properties of materials using for toner including a binder resin, an arrival time for adjusting to a targeted particle diameter is advanced and product collecting rate (yield) rises. Measuring a volume average particle diameter of emulsification dispersions automatically and adjusting automatically depending on a data of relation between a particle diameter and control factors that affect a particle diameter inputted into a computer beforehand so that a toner that has a targeted volume average particle diameter can be obtained. By introducing the system that adjusts the factors that affect a particle diameter automatically, a stable particle diameter change and a sharp emulsification particle diameter distribution are provided. As the result, a good toner of an image quality is provided. As the control factors that affect a particle diameter, peripheral speed of an emulsifier, a rate of O/W, quantity for feeding are included.

Most of ingredients of an emulsification particle are resins, so resin components affects forming of emulsification droplet (cohesion degree). Therefore, it's preferable to determine the most preferable condition for the beginning of manufacturing depending on main properties of binder resins. As the main properties of binder resins, a glass transition temperature, weight-average molecular weight, acid value, half efflux temperature are included.

In addition, introducing a system that has a function for calculating quantity of product collected and a function for calculating a mathematical volume average particle diameter of product collected on a product sampling line, “production of next lots” or “a flow to the next process” takes place smoothly. As the result, a production cycle rotates surely in process cycle time and reduction of personnel expenses is reduced.

Target volume average particle diameter of toner (Dv) is from 3 to 10 μm, preferably from 3 to 7 μm, more preferably from 4 to 6.5 μm.

In addition, when the value of volume average particle diameter of toner (Dv) divided by number average particle diameter of toner (Dn), in other words (Dv/Dn) is from 1.05 to 1.25, the toner has excellent hot storage properties, low temperature image-fixing properties and hot offset-resistance properties. In particular, glossiness is excellent when the toner is used in a full color copier, while in a two-component developer, it is found out that even when refilling and consuming of toner is performed over long period of time, there is less variation of particle diameter distribution of the toner in the developer, and when stirred for long periods in the developing device (image-developer), good, stable development properties can be obtained. When a toner is used as one component developer, even if refilling and consuming of toner is repeated, a change of particle diameter of toner is small. In addition, filming of toner to a development roller, fusion-bonding of toner to members such as blade that is used for lamellation of a toner are prevented, efficient and stable developing characteristics and a excellent image forming were provided, even if agitating of toner was continued for a long term.

In general, it has been said that the smaller the particle diameter is, the higher the resolution and image quality can be obtained. However, this is disadvantageous for transfer properties and cleaning properties. Also, if the volume average particle diameter is too small, in a two-component developer, toners become fused on the surface of a carrier, when stirred during long period of time in the developing device (image-developer), and charging properties of the carrier deteriorate. When used as a single-component developer, filming of the toner occurs on the development roller, and the toner tends to be fused on parts such as blades or the like, which make the layer of the toner thinner.

In particular, if the ratio of amount of the toner having a superfine particle is high, this phenomenon can be happened.

On the other hand, when the particle diameter is too large, it tends to be difficult to obtain a high resolution and high-quality image, and when the toner in the developer is recycled, there is a big difference in the particle diameter among each toner. When the ratio (Dv/Dn) is too large, the similar problem may be happened.

On the other hand, if the ratio (Dv/Dn) is too small, although there are advantages from the viewpoint of stability of toner circulation and uniform charging amount, the toner charge is sometimes insufficient and cleaning is sometimes difficult. Accordingly, the ratio (Dv/Dn) is preferably 1.05 or more.

### <Particle Diameter Distribution of Particles>

The average particle diameter of toner and particle diameter distribution of toner is measured using a COULTER MULTI-SIZER III (manufactured by Beckman Coulter Inc.). Using the aforesaid measuring device, an exclusive analysis software (IBM) and a personal computer (available from IBM) to analyze a data. Kd value is set by means of a normal particle of 10 μm, an aperture current is set as automatic. And a 1% NaCl aqueous solution is prepared using primary purity sodium chloride. Also ISOTON-II (manufactured by Coulter Scientific Japan Inc.) can be used.

The measurement was performed by dispersing a surfactant, preferably 0.1 ml to 5 ml of an alkylbenzene sulfonate, as dispersant in 100 ml to 150 ml of the aforesaid electrolyte solution, adding 2 to 20 mg of the measurement sample, and performing dispersion treatment for approximately 1 to 3 minutes in an ultrasonic disperser. Using an aperture tube of 100 μm, the volume distribution (Dv) and number distribution (Dn) of particles in the range 2 μm and more than 2 μm are measured by counting 50,000 times. And the volume average particle diameter is obtained from volume particle diameter distribution based on volume and the number average particle diameter is obtained from number particle diameter distribution based on number. Particle diameter distribution is sharp so that Dv/Dn is near to 1.0.

According to the present invention, technologies disclosed in JOP 2006-299219 incorporated herein by reference in its entirely. The present invention provides a good result either individually or in combination with following technology.

Prediction convergence value Dv (X) ∞ of emulsification particle diameter is calculated on every measuring point of particle diameter during particle diameter measuring process in the technology disclosed by JOP 2006-299219. A procedure for calculation includes a process for determining of an approximation curve for calculating prediction convergence value Dv (X) ∞, for example a logarithm curve of “w=b/ln(u)+a”, when a and b are the fixed number and a process for calculation of prediction convergence value Dv (X) ∞ of emulsification particle diameter by calculating convergence value u_{inf} as a value of u when a value of particle diameter generally converges and by substituting the value of u_{inf}. Specifically, from emulsification conditions includes RPM (rounds per minute) to agitate, the oil water ratio and temperature among a database of particle diameter measurement results of the past that were emulsified under the same condition as the present emulsification process, choose an approximation type for applying from a quadratic equation, an anti-numerical formula, log type or other type and after that calculate a prediction convergence value Dv (X) ∞ of emulsification particle diameter on each spot for measuring particle diameter using the approximation type.

For other example, (1) deciding an approximation type such as the approximation type mentioned above “w=b·ln (u)+a” when a, b are fixed numbers, from a current condition including RPM (rounds per minute) to agitate, the oil water ratio and temperature as well as a database of particle diameter measurement results of the past that were emulsified under the same condition as the present emulsification process, (2) calculating of u that introduces u_{inf} (this u_{inf} means the minimum of u when the degree of leaning dw/du becomes extremely gentle on a graph of an approximation type “w=b1·ln(u)+a1”) using the approximation type “w=b1·ln(u)+a1” when the fixed numbers a, b of the approximation type that means a particle diameter measurement result of the past are a1, b1, and using the u_{inf} in the calculation for the production condition (when a different production condition is set, it's necessary to have a similar process), (3) getting an approximation curve by plotting (u, w)=(3,Dv₍ₓ₎), (u, w)=(2,Dv₍ₓ₋₁₎), (u, w)=(1,Dv₍ₓ₋₂₎) when Dv (X) is a value in present X, Dv₍ₓ₋₁₎ is a value in a pre-point in time and Dv₍ₓ₋₂₎ is a value in the point in time before last, after that getting the approximation curve “w=b2·ln(u)+a2” by deciding a value of a, b (a2, b2) so that the approximation type (“w=b/ln(u)”+a) being selected in (1) and the approximation type getting by the plotting method become the nearest, (4) calculating Dv (X) ∞ by submitting u_{inf} calculated by (2) in the approximation type “w=b2·ln(u)+a2”, (5) changing a condition when the value of Dv (X) ∞ is not in targeted range, (6) performing the flow from (3) again when the condition is not changed, on the other hand, returning to (1) and calculating prediction convergence value Dv (X) ∞ when the condition is changed. Any similar process to the process of deciding an approximation type such as the approximation type mentioned above “w=b·ln(u)+a”, from a current condition including RPM to agitate, the oil water ratio and temperature as well as a database of particle diameter measurement results of the past that were emulsified under the same condition as the present emulsification process can be applied on the process of deciding “the optimum of starting time depending on the property of toner components including the property of binder resin”.

Examples showed in JOP 2006-299219 (incorporated herein by reference in its entirely) such as a graph which shows a correlative state example between a degree to agitate of an emulsification device and a volume average of particle diameter of an emulsification particle in FIG. 5, a correlative state example between an oil water aspect ratio of an emulsification device and a volume average of particle diameter of an emulsification particle in FIG. 6, and a correlative state example between an emulsification start time of an emulsification device and a volume average of particle diameter of an emulsification particle in FIGS. 7, 8 are also can be referred to.

For a resin used for the present invention, any kind of resin used for normal toner such as styrene acrylic acid resin, polyol resin, a polyester resin can be used. Particularly, for reproduction of full color image, a polyester resin is preferred from the viewpoint of fixity.

### [Modified Polyester Resin]

The modified polyester resin according to the present invention has a structure in which functional group in a monomer unit of acid and alcohol as well as a bonding group other than ester bonds in a polyester resin, or a structure in which resinous components having different structures are bonded in covalent bonding or in ionic bonding.

For example, the polyester terminal can be made to react by a moiety other than an ester bond. Specifically, a functional group such as isocyanate which reacts with acid groups and hydroxyl groups is introduced to the terminal, and reacted with an active hydrogen compound to modify the terminal, or made to undergo an extended reaction.

If the compound contains plural active hydrogen groups, the polyester terminals can be bonded together (e.g., urea-modified polyester, urethane-modified polyester, or the like).

A reactive group such as a double bond can be introduced into the polyester main chain, and a radical polymerization is initiated to introduce a carbon-carbon bonded graft component into the side chain or to crosslink the double bonds (styrene-modified polyester, acryl-modified polyester, or the like).

Alternatively, the resinous component having a different composition in the main chain of the polyester can be copolymerized or reacted with a terminal carboxyl group or hydroxyl group. For example, it can be copolymerized with a silicone resin in which the terminal is modified by carboxyl group, hydroxyl group, epoxy group, or mercapt group (silicone-modified polyester, or the like).

Specific examples will now be described.

### [Urea-Modified Polyester]

Urea-modified polyester (i) preferably for use in the present invention is obtained by reacting a polyester prepolymer (A) having an isocyanate group with the amine (B). The polyester prepolymer (A) having an isocyanate group can be obtained by reacting a polyisocyanate (3) with a polyester having an active hyderogen group which is a polycondensation of the polyol (1) and the polycarboxylic acid (2). Specific examples of the active hydrogen group contained in the polyesters mentioned above include, but are not limited to, hydroxyl groups (alcohol hydroxyl groups and phenol hydroxyl groups), amino groups, carboxylic groups, and mercarpto groups. Among these, alcohol hydroxyl groups are preferred.

Suitable polyols (1) include diols (1-1) and polyols (1-2) having three or more hydroxyl groups. It is preferred to use a diol (1-1) alone or mixtures in which a small amount of a polyol (1-2) is mixed with a diol (1-1). Specific examples of the diols (1-1) include, but are not limited to, alkylene glycol (e.g., ethylene glycol, 1,2-propylene glycol, 1,3-propylene glycol, 1,4-butanediol and 1,6-hexanediol); alkylene ether glycols (e.g., diethylene glycol, triethylene glycol, dipropylene glycol, polyethylene glycol, polypropylene glycol and polytetramethylene ether glycol); alicyclic diols (e.g., 1,4-cyclohexane dimethanol and hydrogenated bisphenol A); bisphenols (e.g., bisphenol A, bisphenol F and bisphenol S); adducts of the alicyclic diols mentioned above with an alkylene oxide (e.g., ethylene oxide, propylene oxide and butylene oxide); and adducts of the bisphenols mentioned above with an alkylene oxide (e.g., ethylene oxide, propylene oxide and butylene oxide); etc. Among these compounds, alkylene glycols having from 2 to 12 carbon atoms and adducts of a bisphenol with an alkylene oxide are preferable. More preferably, adducts of a bisphenol with an alkylene oxide, or mixtures of an adduct of a bisphenol with an alkylene oxide and an alkylene glycol having from 2 to 12 carbon atoms are used.

Specific examples of the polyols (1-2) include, but are not limited to, aliphatic alcohols having three or more hydroxyl groups (e.g., glycerin, trimethylol ethane, trimethylol propane, pentaerythritol and sorbitol); polyphenols having three or more hydroxyl groups (trisphenol PA, phenol novolak and cresol novolak); adducts of the polyphenols mentioned above with an alkylene oxide; etc.

Suitable polycarboxylic acids (2) include dicarboxylic acids (2-1) and polycarboxylic acids (2-2) having three or more carboxyl groups. It is preferred to use dicarboxylic acids (2-1) alone or mixtures in which a small amount of a polycarboxylic acid (2-2) is mixed with a dicarboxylic acid (2-1).

Specific examples of the dicarboxylic acids (2-1) include, but are not limited to, alkylene dicarboxylic acids (e.g., succinic acid, adipic acid and sebacic acid); alkenylene dicarboxylic acids (e.g., maleic acid and fumaric acid); aromatic dicarboxylic acids (e.g., phthalic acid, isophthalic acid, terephthalic acid and naphthalene dicarboxylic acids; etc. Among these compounds, alkenylene dicarboxylic acids having from 4 to 20 carbon atoms and aromatic dicarboxylic acids having from 8 to 20 carbon atoms are preferably used. Specific examples of the polycarboxylic acids (2-2) having three or more hydroxyl groups include, but are not limited to, aromatic polycarboxylic acids having from 9 to 20 carbon atoms (e.g., trimellitic acid and pyromellitic acid). As the polycarboxylic acid (2-2), anhydrides or lower alkyl esters (e.g., methyl esters, ethyl esters or isopropyl esters) of the polycarboxylic acids specified above can be used for the reaction with a polyol.

Suitable mixing ratio (i.e., an equivalence ratio [OH]/[COOH]) of a polyol (1) to a polycarboxylic acid (2) is from 2/1 to 1/1, preferably from 1.5/1 to 1/1 and more preferably from 1.3/1 to 1.02/1.

Specific examples of the polyisocyanates (3) include, but are not limited to, aliphatic polyisocyanates (e.g., tetramethylene diisocyanate, hexamethylene diisocyanate and 2,6-diisocyanate methylcaproate); alicyclic polyisocyanates (e.g., isophorone diisocyanate and cyclohexylmethane diisocyanate); aromatic didicosycantes (e.g., tolylene diisocyanate and diphenylmethane diisocyanate); aromatic aliphatic diisocyanates (e.g., α, α, α′, α′-tetramethyl xylylene diisocyanate); isocyanurates; blocked polyisocyanates in which the polyisocyanates mentioned above are blocked with phenol derivatives, oximes or caprolactams; etc. These compounds can be used alone or in combination.

When a polyester prepolymer (A) having an isocyanate group is obtained, a suitable mixing ratio (i.e., [NCO]/[OH]) of a polyisocyanate (3) to a polyester having a hydroxyl group is from 5/1 to 1/1, preferably from 4/1 to 1.2/1 and more preferably from 2.5/1 to 1.5/1. When the [NCO]/[OH] ratio is too large, the low temperature fixability of the toner easily deteriorates. When the [NCO]/[OH] ratio is too small, the content of the urea in the ester decreases when a modified polyester is used, which leads to deterioration of hot offset resistance. The content of the constitutional component of a polyisocyanate (3) in the polyester prepolymer (A) having a polyisocyanate group at its end portion is from 0.5 to 40% by weight, preferably from 1 to 30% by weight and more preferably from 2 to 20% by weight. A content that is too small tends to degrade the hot offset resistance and is disadvantageous in terms of the combination of the hot offset preservability and the low temperature fixing property. A content that is too large tends to degrade the low temperature fixing property.

The number of isocyanate groups included in the prepolymer (A) per molecule is normally not less than 1, preferably from 1.5 to 3, and more preferably from 1.8 to 2.5. When the number of isocyanate groups is too small, the molecular weight of the urea-modified polyester tends to be small, which degrades the hot offset resistance.

Specific examples of the amine (B) include, but are not limited to, diamines (B1), polyamines (B2) having three or more amino groups, amino alcohols (B3), amino mercaptans (B4), amino acids (B5), and blocked amines (B6), in which the amines (B1-B5) mentioned above are blocked. Specific examples of the diamines (B1) include, but are not limited to, aromatic diamines (e.g., phenylene diamine, diethyltoluene diamine and 4,4′-diaminodiphenyl methane); alicyclic diamines (e.g., 4,4′-diamino-3,3′-dimethyldicyclohexyl methane, diaminocyclohexane and isophoron diamine); aliphatic diamines (e.g., ethylene diamine, tetramethylene diamine and hexamethylene diamine); etc. Specific examples of the polyamines (B2) having three or more amino groups include, but are not limited to, diethylene triamine, triethylene and tetramine. Specific examples of the amino alcohols (B3) include, but are not limited to, ethanol amine and hydroxyethyl aniline. Specific examples of the amino mercaptan (B4) include, but are not limited to, aminoethyl mercaptan and aminopropyl mercaptan. Specific examples of the amino acids (B5) include, but are not limited to, amino propionic acid and amino caproic acid. Specific examples of the blocked amines (B6) include, but are not limited to, ketimine compounds which are prepared by reacting one of the amines B1-B5 mentioned above with a ketone such as acetone, methyl ethyl ketone and methyl isobutyl ketone; oxazoline compounds, etc. Among these compounds, diamines (B1) and mixtures in which a diamine (B1) is mixed with a small amount of a polyamine (B2) are preferable.

Furthermore, the molecular weight of the polyesters can be controlled when a prepolymer (A) and an amine (B) are reacted, if desired. Specific examples of such molecular weight control agents include, but are not limited to, monoamines (e.g., diethyl amine, dibutyl amine, butyl amine and lauryl amine) having no active hydrogen group, and blocked amines (i.e., ketimine compounds) prepared by blocking the monoamines specified above.

The mixing ratio of the amines (B) to the prepolymer (A), i.e., the equivalent ratio ([NCO]/[NHx]) of the isocyanate group [NCO] contained in the prepolymer (A) to the amino group [NHx] contained in the amines (B), is normally from 1/2 to 2/1, preferably from 1.5/1 to 1/1.5 and more preferably from 1.2/1 to 1/1.2. When the mixing ratio is too large or too small, the molecular weight of the polyester decreases, resulting in deterioration of the hot offset resistance of the resultant toner.

The mixing ratio of the amines (B) to the prepolymer (A), i.e., the equivalent ratio ([NCO]/[NHx]) of the isocyanate group [NCO] contained in the prepolymer (A) to the amino group [NHx] contained in the amines (B), is normally from 1/2 to 2/1, preferably from 1.5/1 to 1/1.5 and more preferably from 1.2/1 to 1/1.2. When the mixing ratio is too large or too small, the molecular weight of the resultant polyester decreases, resulting in deterioration of the hot offset resistance of the resultant toner. In the present invention, the polyester based resins (polyester) preferably used as the binder resin are urea-modified polyesters (i). These urea-modified polyesters (i) can include a urethane linkage as well as a urea linkage. The molar ratio of the content of the urea linkage to the content of the urethane linkage may vary from 100/0 to 10/90, preferably from 80/20 to 20/80 and more preferably from 60/40 to 30/70. When the content of the urea linkage is too low, the hot offset resistance of the resultant toner tends to deteriorate.

The urea-modified polyesters (i) of the present invention can be prepared in different ways, including, for example, one-shot methods. The weight-average molecular weight of the urea-modified polyesters (i) is not less than 10,000, preferably from 20,000 to 10,000,000 and more preferably from 30,000 to 1,000,000. When the weight-average molecular weight is too small, the hot offset resistance property easily deteriorates. The number-average molecular weight of the urea-modified polyesters is not particularly limited when the unmodified polyester (PE) described below is used in combination. Namely, controlling of the weight-average molecular weight of the modified polyester resins has priority over controlling of the number-average molecular weight thereof. However, when a urea-modified polyester (i) is used alone, the number-average molecular weight thereof ranges from 2,000 to 20,000, preferably from 2,000 to 10,000 and more preferably from 2,000 to 8,000. When the number-average molecular weight is too large, the low temperature fixability of the resultant toner tends to deteriorate, and in addition the gloss of full color images deteriorates when the toner is used in a full color image forming apparatus.

### [Unmodified Polyester]

In the present invention, the modified polyester such as the urea-modified polyester (i) can be used in combination with an unmodified polyester (ii) contained as the binder resin component. By using a combination of a urea-modified polyester (i) with an unmodified polyester (ii), the low temperature fixability of the toner improves and in addition the toner can produce color images having high gloss when the toner is used in a full-color image forming apparatus. The combinational use is preferred to a single use of the modified polyester. Specific examples of the polyester (ii) include, but are not limited to, polycondensation products of the polyol (1) and the polycalboxylic acid (2) specified for the polyester component of the urea-modified polyester (i) and preferred examples thereof are the same as those for the urea-modified polyester (i). In addition to the non-modified polyester, modified polyesters modified by a chemical linkage other than urea linkage, for example, urethane linkage can be used. The urea-modified polyester (i) and the non-modified polyester (ii) are preferred to be at least partially compatible with each other to improve the low temperature fixability and hot offset resistance properties. Therefore, it is preferable, but not mandatory, that the polyester component in the urea-modified polyester (i) has a similar composition to that of the non-modified polyester (ii). The weight ratio of the urea-modified polyester/the non-modified polyester is normally from 5/95 to 80/20, preferably from 5/95 to 30/70, more preferably from 5/95 to 25/75 and even more preferably from 7/93 to 20/80. A content of the urea-modified polyester (i) that is too small tends to degrade the hot offset resistance of the toner and in addition be disadvantageous in terms of a good combination of the high temperature preservability and low temperature fixability.

The peak molecular weight of the non-modified polyester resin (ii) is usually 1,000 to 30,000, is preferably 1,500 to 10,000 and is more preferably 2,000 to 8,000. If it is less than 1,000, high temperature preservability properties deteriorate. If it is more than 30,000, low temperature image-fixing properties deteriorate. The hydroxyl value of the non-modified polyester resin (ii) is preferably 5 or more, is more preferably 10 to 120 and is still more preferably 20 to 80. If it is less than 5, it is disadvantageous from the viewpoint of obtaining both high temperature preservability properties and low temperature image-fixing properties at the same time. The acid value of the non-modified polyester resin (ii) is preferably 1 to 30, is more preferably 5 to 20. By giving the acid value, a negative electrostatic charge can be easily acquired.

In the present invention, the glass transition temperature (Tg) of binder resin for toner is usually 50° C. to 70° C., and preferably 55° C. to 65° C. If the glass transition temperature (Tg) is less than 50° C., high temperature preservability properties of the toner deteriorate. If it is more than 70° C., low temperature image-fixing properties of the toner is insufficient. In a dry toner such as the toner for developing a latent electrostatic image of the present invention, due to the presence of the modified polyester resin (i), high temperature preservability properties tend to be good, compared to the polyester toners known in the art, even if the glass transition temperature is low.

In the present invention, the temperature (TG′) at which the storage modulus of the binder resin of the toner is 10000 dyne/cm2 at a frequency of 20 Hz, is usually 100° C. or higher, and is preferably 110° C. to 200° C. If it is less than 100° C., hot offset-resistance properties deteriorate.

The temperature (Tη) at which the viscosity of the binder resin of the toner is 1000 poise at a frequency of 20 Hz, is usually 180° C. or less, and is preferably 90° C. to 160° C. If it is more than 180° C., low temperature image-fixing properties deteriorate. Specifically, from the viewpoint of obtaining both low temperature image-fixing properties and hot offset-resistance properties at the same time, TG′ is preferably higher than Tη. In other words, the difference (TG′−Tη) of TG′ and Tη is preferably 0° C. or more. It is more preferably 10° C. or more, and is still more preferably 20° C. or more. There is no particular restriction as to the upper limit. From the viewpoint of obtaining both heat-resistant storage properties and low temperature image-fixing properties at the same time, the difference of Tη and Tg is preferably 0° C. to 100° C., is more preferably 10° C. to 90° C. and still more preferably 20° C. to 80° C.

### [Coloring Agent]

There is no specific limit to the coloring agents for use in the toner. Specific examples thereof include, but are not limited to, carbon black, Nigrosine dyes, black iron oxide, Naphthol Yellow S, HANSA Yellow (10G, 5G and G), Cadmium Yellow, yellow iron oxide, loess, chrome yellow, Titan Yellow, polyazo yellow, Oil Yellow, HANSA Yellow (GR, A, RN and R), Pigment Yellow L, Benzidine Yellow (G and GR), Permanent Yellow (NCG), Vulcan Fast Yellow (5G and R), TartrazineLake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, p-chloro-o-nitroaniline red, LITHOL Fast Scarlet G, Brilliant Fast Scarlet, Brilliant Carmine BS, Permanent Red (F2R, F4R, FRL, FRLL and F4RH), Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, PYRAZOLONE Red, polyazo red, Chrome Vermilion, Benzidine Orange, perynone orange, Oil Orange, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and a mixture thereof. The content of such a coloring agent is from 1 to 15% by weight and preferably from 3 to 10% by weight based on the content of toner.

Master batch pigments, which are prepared by combining a coloring agent with a binder resin, can be used as the coloring agent of the toner composition of the present invention. Specific examples of the binder resins for use in the master batch pigments or for use in combination with master batch pigments include, but are not limited to, the modified polyester resins and the unmodified polyester resins mentioned above; styrene polymers and substituted styrene polymers such as polystyrene, poly-p-chlorostyrene and polyvinyltoluene; styrene copolymers such as styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers; and other resins such as polymethyl methacrylate, polybutyl methacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosins, terpene resins, aliphatic or alicyclic hydrocarbon resins, aromatic petroleum resins, chlorinated paraffin, paraffin waxes, etc. These resins can be used alone or in combination.

The master batch mentioned above is typically prepared by mixing and kneading a resin and a coloring agent upon application of high shear stress thereto. In this case, an organic solvent can be used to boost the interaction of the coloring agent with the resin. In addition, flushing methods in which an aqueous paste including a coloring agent is mixed with a resin solution of an organic solvent to transfer the coloring agent to the resin solution and then the aqueous liquid and organic solvent are removed can be preferably used because the resultant wet cake of the coloring agent can be used as it is, i.e., dispensing with drying. In this case, a high shear dispersion device such as a three-roll mill is preferably used for mixing and kneading the mixture.

### [Release Agent]

The toner of the present invention may also contain wax together with the binder resin and the coloring agent of the toner. The wax may be any of those known in the art Examples of the wax are polyolefin wax (polyethylene wax, polypropylene wax, or the like); a long chain hydrocarbon (paraffin wax, Sasol wax, or the like); a carbonyl group-containing wax, and the like. of these, the carbonyl group-containing wax is preferred. Examples of the carbonyl group-containing wax is polyalkane acid esters (carnauba wax, montan wax, trimethyloylpropane tribehenate, pentaerythrytol tetrabehenate, pentaerythrytol diacetate dibehenate, glyceryl tribehenate, 1,18-octadecanediol distearate, or the like); polyalkenol esters (trimellitic acid tristearyl, distearyl maleate, or the like); polyalkane acid amides (ethylenediamine dibehenylamide, or the like); polyalkylamides (trimellitic tristearylamides, or the like); dialkyl ketones (distearylketone, or the like), and the like. Of the carbonyl group-containing wax, the polyalkane acid esters are preferred. The melting point of the wax used in the present invention is usually 40° C. to 160° C., is preferably 50° C. to 120° C. and is more preferably 60° C. to 90° C. If the melting point of the wax is less than 40° C., there is an adverse effect on heat resistance storage properties. If the melting point of the wax is more than 160° C., cold offset during image-fixing tends to occur at low temperature. Further, the melting viscosity of the wax is preferably 5 cps to 1000 cps, is more preferably 10 cps to 100 cps, which is the value measured at a temperature 20° C. higher than the melting point. If the melting viscosity of the wax is more than 1000 cps, there is not much improvement of hot offset-resistance properties and low temperature image-fixing properties. The content of the wax in the toner is usually 0% by weight to 40% by weight, and is preferably 3% by weight to 30% by weight.

### [Charge Control Agent]

The toner of the present invention optionally includes a charge control agent. Any known charge controlling agent can be used. Specific examples thereof include, but are not limited to, nigrosine dyes, triphenylmethane dyes, chrome containing metal complex dyes, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid, metal salts of salicylic acid derivatives, etc. Specific examples thereof include, but are not limited to, BONTRON 03 (nigrosine dye), BONTRON P-51 (quaternary ammonium salt), BONTRON S-34 (metal containing azo dye), E-82 (metal complex of oxynaphthoic acid), E-84 (metal complex of salicylic acid), and E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE PR (triphenyl methane derivative), COPY CHARGE NEG VP2036 and NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments and polymers having a functional group, for example, sulfonic acid group, carboxyl group, quaternary ammonium group, etc.

The content of the charge control agent is determined depending on the kind of the binder resin used, whether or not an additive is added, and the toner manufacturing method including the dispersion method. Therefore, it is not easy to jump to any conclusion but the content of the charge control agent is preferably from 0.1 to 10 parts by weight, and more preferably from 0.2 to 5 parts by weight based on 100 parts by weight of the binder resin included in the toner. When the content is too large, the toner tends to have too large chargeability, which leads to reduction in the effect of a main charge control agent, and thereby the electrostatic force with a developing roller increases, resulting in deterioration of the fluidity of the toner and a decrease in the image density of toner images. These charge control agents and releasing agents can be melted, mixed and kneaded with a master batch and a binder resin or added when dissolved or dispersed in an organic solvent.

### [Method of Manufacturing Toner in Aqueous Medium]

Suitable aqueous media for use in the present invention include water, and mixtures of water with a solvent which can be mixed with water. Specific examples of such a solvent include, but are not limited to, alcohols (e.g., methanol, isopropanol and ethylene glycol), dimethylformamide, tetrahydrofuran, cellosolves (e.g., methyl cellosolve), lower ketones (e.g., acetone and methyl ethyl ketone), etc.

The binder resin for toner can be manufactured by the following methods, etc.

Polyol (1) and Polycarboxylic acid (2) are heated under the presence of a known esterification catalyst such as tetrabuthoxy titanate and dibutyltin oxide to a temperature of from 150 to 280° C. with a reduced pressure, if desired, while removing produced water to obtain a polyester having a hydroxyl group. Then, polyisocyanate (3) is reacted with the polyester in the temperature range of from 40 to 140° C. to obtain polyester prepolymer (A) having an isocyanate group. The polyester prepolymer (A) is reacted with amine (B) at the temperature range of from 0 to 140° C. to obtain a urea-modified polyester (i). When the polyisocyanate (3) is reacted or the polyester prepolymer (A) and the amine (B) are reacted, a solvent can be used, if desired.

Specific examples thereof include, but are not limited to, aromatic solvents (e.g., toluene and xylene), ketones (e.g., acetone, methylethylketone and methylisobutyl ketone), esters (e.g., ethyl acetate), amides (e.g., dimethylformamide and dimethylacetamide), and ethers (e.g., tetrahydrofuran), which are inactive with a polyisocyanate (3). When polyester (ii) not modified with a urea-linkage is used in combination, this polyester (ii) is prepared by the same method as the method for a polyester having a hydroxyl group and is dissolved and mixed in the solution of the urea-modified polyester obtained after the reaction is complete.

An organic solvent in which a polyester, for example, a urea-modified polyester (i) and a prepolymer (A), is soluble can be used to decrease the viscosity of a medium dispersion containing a toner component. The organic solvent is preferred to be volatile and have a boiling point lower than 100° C. since it is easy to remove such an organic solvent. Specific examples thereof include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methylethyl ketone and methylisobutyl ketone. These can be used alone or in combination. Especially, aromatic series based solvent, for example, toluene and xylene, and halogenated hydrocarbons, for example, methylene chloride, 1,2-dichloroethane, chloroform and carbon tetrachloride, are preferred. And a solvent which is dissolved in an aqueous media such as an alcohol and water can be used together so that a shape of toner can be regulated effectively. The content of the organic solvent is from 10 to 900 parts by weight based on 100 parts by weight of a toner composition.

In the present invention, the particles of toner may be formed by reacting a dispersant in a volatile organic solvent comprising a prepolymer (A) having isocyanate groups and other toner components with amines (B) in the aqueous medium, or the modified polyester resin (i) manufactured previously, may be used.

As a method of stably forming a dispersion body formed of a reactive modified polyester and a prepolymer (A) such as a urea-modified polyester in an aqueous medium, there is a method in which a composition of a toner material formed of a reactive modified polyester and a prepolymer (A) such as a urea-modified polyester is added to an aqueous medium followed by dispersion using a shearing force. A reactive modified polyester such as prepolymer (A) and other toner composition such as a coloring agent, a coloring agent master batch, a releasing agent and a non-modified polyester resin can be mixed in an aqueous medium when a dispersion body is formed. However, it is preferred that the toner compositions are preliminarily mixed and then the mixture is added to and dispersed in an aqueous medium.

The dispersion method is not particularly limited. Specific examples thereof include, but are not limited to, a homogenizer includes a high-speed body of rotation and a stator, a high pressure homogenizer and a dispersion machine with the use of a media such as a ball mill, a bead mill as well as a sand mill. Also, in the present invention, the other toner compositions such as a coloring agent, a releasing agent and a charge control agent are not necessarily mixed when particles are granulated in an aqueous medium. For example, the other components can be added by a known dying method after particles are granulated without a coloring agent.

The dispersion method is not particularly limited. Specific examples thereof include, but are not limited to, low speed shearing methods, high speed shearing methods, friction methods, high pressure jet methods, ultrasonic methods, etc. Among these methods, high speed shearing methods are preferable because particles having a particle diameter of from 2 to 20 μm can be easily prepared. At this point, the particle diameter (2 to 20 μm) means a particle diameter of particles including a liquid. Specific examples of the marketed dispersing machines of this type include continuous dispersing machines such as ULTRA-TURRAX® (from IKA Japan), POLYTRON® (from KINEMATICA AG), TK AUTO HOMO MIXER® (from PRIMIX Co., Ltd.), EBARA MILDER® (from Ebara Corporation), TK PIPELINE HOMO MIXER® (from Tokushu Kika Kogyo Co., Ltd.), TK HOMOMIC LINE FLOW® (from Tokushu Kika Kogyo Co., Ltd.), colloid mill (from SHINKO PANTEC CO., LTD.), slasher, trigonal wet pulverizer (from Mitsui Miike Machinery Co., Ltd.), CAVITRON® (from Eurotec), and FINE FLOW MILL® (from Pacific Machinery & Engineering Co., Ltd.); and batch type emulsifiers or batch/continuous emulsifiers such as CLEARMIX® (from M Technique) and FILMICS (from Tokushu Kika Kogyo Co., Ltd.).

When a high speed shearing type dispersion machine is used, the rotation speed is not particularly limited, but the rotation speed is typically from 1,000 to 30,000 rpm, and preferably from 5,000 to 20,000 rpm. The dispersion time is not particularly limited, but is typically from 0.1 to 5 minutes. The temperature in the dispersion process is typically from 0 to 150° C. (under pressure), and preferably from 10 to 98° C. When the temperature is preferably high, the viscosity formed of a urea-modified polyester or a prepolymer (A) is low, which is advantageous for easy dispersion.

The amount of an aqueous medium is normally from 50 to 2,000 parts by weight and preferably from 100 to 1,000 parts by weight based on 100 parts by weight of a toner composition containing a polyester such as a urea modified polyester and a prepolymer (A). When the amount of an aqueous medium is too small, the dispersion stability of a toner composition is degraded so that toner particles having a desired particle diameter are not obtained. An amount of an aqueous medium that is excessively large is not preferred in light of economy. Solid fine particles are dispersed in aqueous media and other dispersion agent can be used together to adjust adsorption characteristics of a dispersion agent to a droplet. Other dispersion agent can be added before a emulsification of toner or at time to remove volatile constituent after emulsification.

### [Particulate Dispersion Agent]

As a solid particulate dispersion agent, insoluble in water and stable as a solid agents which have an average particle diameter from 0.01 to 1 μm can be used.

Specific examples of such inorganic particulates include, but are not limited to, silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, silicon nitride, etc.

It is preferred to use tricalcium phosphate, calcium carbonate, colloidal titanium oxide, colloidal silica, hydroxyapatitte can be used, too. Particularly it is preferred to use hydroxyapatitte synthesized from sodium phosphate and a calcium chloride with water.

As an organic solid particulate dispersion agent, a crystallite of low molecule organic compound and macromolecule system particle can be used. As polymerized particles manufactured by soap-free emulsion polymerization, suspension polymerization or dispersion polymerization, particles of polystyrene, methacrylic acid ester and acrylic ester copolymer copolymerized with a monomer which has a carboxyl group such as methacrylic acid can be used. And also polymer particles of condensation polymers such as silicone, benzoguanamine, nylon, or the like; polymer particles of thermosetting resins may be used.

After adjusting of solid particulate dispersion agent in water, an inorganic material can be dissolved in acid such as tricalcium phosphate may be partially dissolved by adding appropriate quantity of acid such as hydrochloric acid beforehand. Quantity of the acid is from 0.01 to 10% preferably from 0.1 to 5% of the quantity that can completely dissolve inorganic material.

When material can be dissolved in alkali such as Macromolecule system particle copolymerized with an acrylic acid (methacrylic acid) which has a carboxyl group such as methacrylic acid may be partially dissolved by adding appropriate quantity of alkali such as sodium hydrate beforehand. Quantity of the alkali is from 0.01 to 10% preferably from 0.1 to 5% of the quantity that can completely dissolve inorganic material.

### [Dispersion Agent]

Specific examples of the particulate dispersion agents include, but are not limited to, anionic dispersion agents, for example, alkylbenzene sulfonic acid salts, α-olefin sulfonic acid salts, and phosphoric acid salts; cationic dispersion agents, for example, amine salts (e.g., alkyl amine salts, aminoalcohol fatty acid derivatives, polyamine fatty acid derivatives and imidazoline), and quaternary ammonium salts (e.g., alkyltrimethyl ammonium salts, dialkyldimethyl ammonium salts, alkyldimethyl benzyl ammonium salts, pyridinium salts, alkyl isoquinolinium salts and benzethonium chloride); nonionic dispersion agents, for example, fatty acid amide derivatives, polyhydric alcohol derivatives; and ampholytic dispersion agents, for example, alanine, dodecyldi(aminoethyl)glycin, di(octylaminoethyle)glycin, and N-alkyl-N,N-dimethylammonium betaine.

Using a surface active agent having a fluoroalkyl group in an extremely small amount is effective for good dispersion. Preferred specific examples of the anionic surface active agents having a fluoroalkyl group include, but are not limited to, fluoroalkyl carboxylic acids having from 2 to 10 carbon atoms and their metal salts, disodium perfluorooctane sulfonyl glutamate, sodium 3-{omega-fluoroalkyl(C6-C11)oxy}-1-alkyl(C3-C4) sulfonate, sodium 3-{omega-fluoroalkanoyl(C6-C8)-N-ethylamino}-1-propanesulfonate, fluoroalkyl(C11-C20) carboxylic acids and their metal salts, perfluoroalkylcarboxylic acids and their metal salts, perfluoroalkyl(C4-C12)sulfonate and their metal salts, perfluorooctanesulfonic acid diethanol amides, N-propyl-N-(2-hydroxyethyl)perfluorooctanesulf one amide, perfluoroalkyl (C6-C10)sulfoneamidepropyltrimethylammonium salts, salts of perfluoroalkyl(C6-C10)-N-ethylsulfonyl glycin, monoperfluoroalkyl(C6-C16)ethylphosphates, etc.

Specific examples of the marketed products of such anionic surface active agents having a fluoroalkyl group include, but are not limited to, SURFLON® S-111, S-112 and S-113, which are manufactured by Asahi Glass Co., Ltd.; FRORARD® FC-93, FC-95, FC-98 and FC-129, which are manufactured by Sumitomo 3M Ltd.; UNIDYNE® DS-101 and DS-102, which are manufactured by Daikin Industries, Ltd.; MEGAFACE® F-110, F-120, F-113, F-191, F-812 and F-833 which are manufactured by Dainippon Ink and Chemicals, Inc.; ECTOP® EF-102, 103, 104, 105, 112, 123A, 306A, 501, 201 and 204, which are manufactured by Tohchem Products Co., Ltd.; FUTARGENT® F-100 and F150 manufactured by Neos; etc.

Specific examples of the cationic surface active agents having a fluoroalkyl group include, but are not limited to, primary or secondary aliphatic or secondary amino acids, aliphatic quaternary ammonium salts (for example, perfluoroalkyl(C6-C10)sulfoneamidepropyltrimethyl ammonium salts), benzalkonium salts, benzetonium chloride, pyridinium salts, and imidazolinium salts. Specific examples of the marketed products of such catiotic surface active agents having a fluoroalkyl group include, but are not limited to, SURFLON® S-121 (from Asahi Glass Co., Ltd.); FRORARD FC-135 (from Sumitomo 3M Ltd.); UNIDYNE® DS-202 (from Daikin Industries, Ltd.); MEGAFACE® F-150 and F-824 (from Dainippon Ink and Chemicals, Inc.); ECTOP® EF-132 (from Tohchem Products Co., Ltd.); FUTARGENT® F-300 (from Neos); etc.

Furthermore, toner components can be stably dispersed in an aqueous medium by using a polymeric protection colloid in combinational use with the inorganic dispersing agents and particulate polymers mentioned above. Specific examples of such polymeric protection colloids include, but are not limited to, polymers and copolymers prepared using monomers, for example, acids (e.g., acrylic acid, methacrylic acid, α-cyanoacrylic acid, α-cyanomethacrylic acid, itaconic acid, crotonic acid, fumaric acid, maleic acid and maleic anhydride), acrylic monomers having a hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, N-methylolacrylamide and N-methylolmethacrylamide), vinyl alcohol and its ethers (e.g., vinyl methyl ether, vinyl ethyl ether and vinyl propyl ether), esters of vinyl alcohol with a compound having a carboxyl group (i.e., vinyl acetate, vinyl propionate and vinyl butyrate); acrylic amides (e.g., acrylamide, methacrylamide and diacetoneacrylamide) and their methylol compounds, acid chlorides (e.g., acrylic acid chloride and methacrylic acid chloride), and homopolymers or copolymers having a nitrogen atom or an alicyclic ring having a nitrogen atom (e.g., vinyl pyridine, vinyl pyrrolidone, vinyl imidazole and ethylene imine). In addition, polymers, for example, polyoxyethylene based compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters), and cellulose compounds, for example, methyl cellulose, hydroxyethyl cellulose and hydroxypropyl cellulose, can also be used as the polymeric protective colloid.

When a dispersion agent is used, the dispersion agent may be remained on the surface of toner particle. It's preferable to remove remained solid particulate dispersion agent by washing with solvent after elongation or cross-linking so that toner maintain a excellent property for charging.

The cross-linking time and/or the elongation time is determined depending on the reactivity determined by the combination of the structure of the isocyanate group in a prepolymer (A) and an amine (B). The cross-linking time and/or the elongation time is in general from 10 minutes to 40 hours, and preferably from 2 to 24 hours. The reaction temperature is generally from 0 to 150° C., and preferably from 40 to 98° C. In addition, a known catalyst can be optionally used. Specific examples of such elongation agents and/or cross-linking agents include, but are not limited to, dibutyltin laurate and dioctyltin laurate.

To remove the organic solvent from the obtained emulsification dispersant, the temperature of the whole system is gradually raised, and the organic solvent in the liquid drops is completely removed by evaporation. Alternatively, the emulsification dispersant is sprayed into a dry atmosphere to completely remove the water-insoluble organic solvent in the liquid drops and form toners, and aqueous dispersing agent is removed at the same time by evaporation. The dry atmosphere into which the emulsification dispersant is sprayed, is generally a heated gas such as air, nitrogen, carbon dioxide or combustion gas, the gas flow heated to a temperature above the boiling point of the highest-boiling solvent used. The desired product quality can be obtained in a short time by using a spray dryer, belt dryer, rotary kiln, or the like.

If the particle diameter distribution during emulsification dispersion is large, and washing or drying are performed while maintaining this particle size distribution, the particle siameter distribution can be adjusted a desired particle size distribution by classifying.

The classifying is performed by removing particles from the liquid using a cyclone, decanter, centrifugal separation, or the like. The classifying can of course be performed after obtaining the dry powder. It is preferred from the viewpoint of efficiency to perform this in the liquid. The toners that are not necessary or coarse toners can be recycled to the melt kneading step to form desirable toners. In that case, the toners that are not nor coarse toners may be in wet.

It is preferred that the dispersing agent is removed from the obtained dispersion as much as possible, and this is preferably done at the same time as the classifying described above.

The obtained powder of the toners after drying may be mixed with other particles such as release agent, charge control substance, fluidizer, fine particles of coloring agent, and the like, fixed on the surface by giving a mechanical shock to the mixed powder and melted to prevent separation of the other particles from the surface of the obtained the mixture of the particles.

Specific methods for doing this are giving an impact to the mixture include: into high speed rotating vane, or by introducing the mixture into a high-speed gas flow, and accelerating so that the particles collide with each other or the complex particles are made to strike a suitable impact plate. The device used for this purpose may be an angmill (available from Honkawa Micron) or i-mill (available from Japan Pneumatic) which are modified to reduce the air pressure upon pulverizing, a hybridization system (available from Nara Machine Laboratories), a krypton system (available from Kawasaki Heavy Industries), an automatic mortar, or the like.

### [Method of Manufacturing Dry Toner]

The toner of the present invention can be manufactured by the following method but the method of manufacturing the toner is not limited thereto.

Also in the preparation of the toner, in order to enhance toner fluidity, storage properties, development properties and transfer properties, inorganic particles such as the aforesaid hydrophobic silica particles may be added to the toner thus manufactured. The mixing of the external additives may be performed in an ordinary powder mixer. It is preferred to further provide a jacket or the like, so that the temperature inside the ordinary powder mixer can be adjusted. To modify the negative charge imparted to the external additives, the external additives may be added midway or be added gradually during the process. Speed of rotation, speed of rolling motion, time, temperature, or the like may of course also be varied. A strong negative charge may first be given followed by a relatively weak negative charge. The relatively weak negative charge may first be given followed by the strong negative charge.

Examples of mixing devices which can be used are a V-shaped mixer, rocking mixer, redige mixer, nauta mixer, Henschel mixer, and the like.

To render the toner thus obtained spherical, the toner materials comprising the binder resin and coloring agent which have been melt kneaded and pulverized, may be made spherical by mechanical means using a hybrid mixer or Mechanofusion, or by the spray dry method in which the toner materials are dissolved and dispersed in a solvent in which the binder resin of the toner is soluble, then the solvent is removed using a spray dry apparatus. Alternatively, the toner may be rendered spherical by heating in an aqueous medium, but these methods are not limited thereto.

### [External Additive]

An external additive can be added to the toner of the present invention to help improving the fluidity, developability, chargeability of coloring agents. Inorganic particulates are suitably used as such an external additive. It is preferred for the inorganic particulate to have a primary particle diameter of from 5 nm to 2 μm, and more preferably from 5 nm to 500 nm. In addition, it is preferred that the specific surface area of such inorganic particulates measured by the BET method is from 20 to 500 m²/g. The content of such an inorganic particulate is preferably from 0.01 to 5% by weight and particularly preferably from 0.01 to 2.0% by weight based on the weight of a toner. Specific examples of such inorganic particulates include, but are not limited to, silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, silicon nitride, etc.

In addition, polymerized particles of polystyrene, methacrylic acid ester and acrylic ester copolymer manufactured by soap-free emulsion polymerization, suspension polymerization or dispersion polymerization, and also polymer particles of condensation polymers such as silicone, benzoguanamine, nylon, or the like; polymer particles of thermosetting resins may be used.

If these fluidizers (inorganic particles) are surface-treated to increase hydrophobicity, loss of fluidability and charging properties can be prevented even under high humidity. Examples of suitable surface treatment agents are silane coupling agents, silylating agents, silane coupling agents having a fluorinated alkyl group, organic titanate coupling agents, aluminium coupling agents, silicone oil, modified silicone oil, and the like.

A cleaning improving agent can also be added in order to remove the developer remaining on the photoconductor after transfer or the primary transfer to the recording medium (transfer paper). The cleaning improving agent may be a fatty acid metal salt such as zinc stearate, calcium stearate, stearic acid, or the like; or polymer particles manufactured by soap-free emulsion polymerization such as polymethylmethacrylate particles, polystyrene particles, or the like. The polymer particles preferably have a relatively narrow particle size distribution, and a volume average particle diameter of 0.01 μm to 1 μm.

### [Carrier for Two-Component Developing Agent]

The toner of the present invention can be mixed with a magnetic carrier to be used as a two-component developing agent. The density of the toner to the carrier is preferably from 1 to 10% by weight. Suitable magnetic carriers for use in a two component developer include, but are not limited to, known carrier materials such as iron powders, ferrite powders, magnetite powders, and magnetic resin carriers, which have a particle diameter of from about 20 to about 200 μm. The surface of the carriers may be coated by a resin. It is preferred to coat the surface of the carriers with a resin layer. Specific examples of such resins include, but are not limited to, amino resins such as urea-formaldehyde resins, melamine resins, benzoguanamine resins, urea resins, and polyamide resins, and epoxy resins. In addition, vinyl or vinylidene resins such as acrylic resins, polymethylmethacrylate resins, polyacrylonitirile resins, polyvinyl acetate resins, polyvinyl alcohol resins, polyvinyl butyral resins, polystyrene resins, styrene-acrylic copolymers, halogenated olefin resins such as polyvinyl chloride resins, polyester resins such as polyethylene terephthalate resins and polybutylene terephthalate resins, polycarbonate resins, polyethylene resins, polyvinyl fluoride resins, polyvinylidene fluoride resins, polytrifluoroethylene resins, polyhexafluoropropylene resins, vinylidenefluoride-acrylate copolymers, vinylidenefluoride-vinylfluoride copolymers, copolymers of tetrafluoroethylene, vinylidenefluoride and other monomers including no fluorine atom, and silicone resins.

If desired, an electroconductive powder can be contained in the toner. Specific examples of such electroconductive powders include, but are not limited to, metal powders, carbon blacks, titanium oxide, tin oxide, and zinc oxide. The average particle diameter of such electroconductive powders is preferably not greater than 1 μm. When the particle diameter is too large, controlling the resistance of the resultant toner tends to be difficult.

The toner of the present invention can also be used as a one-component magnetic developer or a one-component non-magnetic developer.

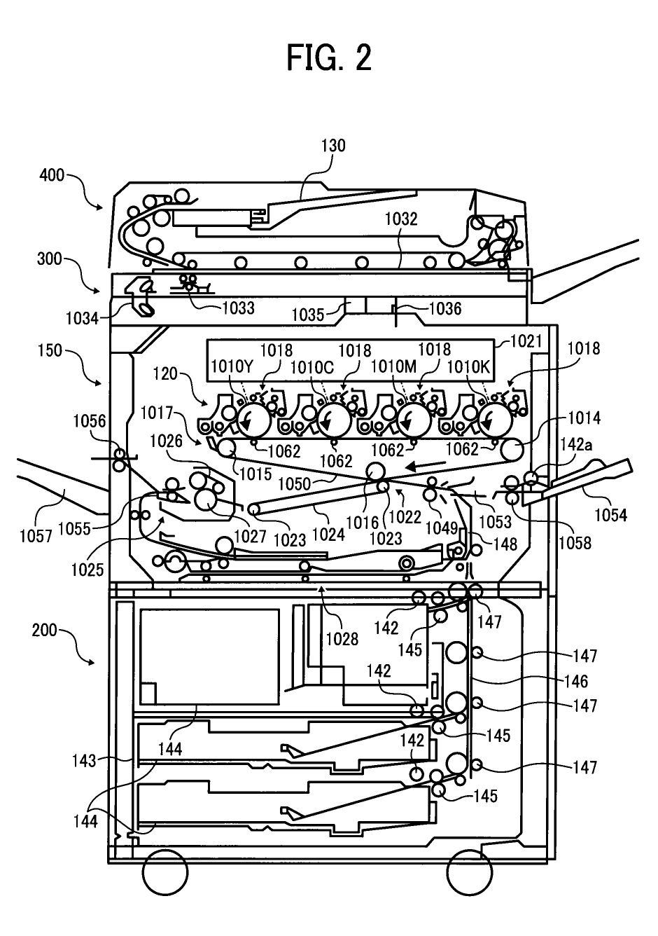

An embodiment of the image formation by the image forming apparatus of the present invention is described with reference to FIG. 2. The tandem image forming apparatus illustrated in FIG. 2 is a tandem type color image forming apparatus. The tandem type image forming apparatus includes a main body 150, a paper feeder table 200, a scanner 300 and an automatic document feeder (ADF) 400.

The main body 150 has an intermediate transfer body 1050 having an endless belt form arranged in the center of the main body 150. The intermediate transfer body 1050 is suspended over supporting rollers 1014, 1015 and 1016 and can rotate clockwise in FIG. 2. An intermediate transfer body cleaning device 1017 is arranged in the vicinity of the supporting roller 1015 to remove the toner remaining on the intermediate transfer body 1050. A tandem type development unit 120 is provided along the intermediate transfer body 1050 and includes four image formation devices 1018 of yellow, cyan, magenta, and black arranged along the moving direction of the intermediate transfer body 1050 while opposing the intermediate transfer body 1050 suspended over the supporting rollers 1014 and 1015. In irradiation device 1021 is situated close to the tandem type development unit 120. A secondary transfer device 1022 is provided on the opposite side of the tandem type development unit 120 and includes a secondary transfer belt 1024 (an endless belt) and a pair of rollers 1023 suspending the secondary transfer belt 1024. A transfer sheet transferred on the secondary transfer belt 1024 can contact with the intermediate transfer body 1050. A fixing device 1025 is arranged in the vicinity of the secondary transfer device 1022 and includes a fixing belt 1026 and a pressing roller 1027 pressed thereby.

Also, a sheet reversing device 28 is arranged near the secondary transfer device 1022 and the fixing device 1025 to reverse the side of the transfer sheet for duplex printing.

Next, full color image formation by the tandem type development unit 120 is described. An original is set on a manual table 130 of the automatic document feeder 400 or a contact glass 1032 of a scanner 300 after the automatic document feeder 400 is open and then the automatic document feeder 400 is closed.

When a start switch (not shown) is pressed, the scanner 300 is driven and a first carrier 1033 and a second carrier 1034 travel immediately in the case in which the original is set on the contact glass 1032 or after the original is transferred to the contact glass 1032 in the case in which an original is set on the automatic document feeder 400. The original is irradiated with light from the light source by the first carrier 1033 and the reflected light from the original is reflected by a mirror of the second carrier 1034. Then, the reflected light is received at a scanning sensor 1036 by way of an image focus lens 1035 to read the color original (color image) and obtain image information of black, yellow, magenta and cyan.

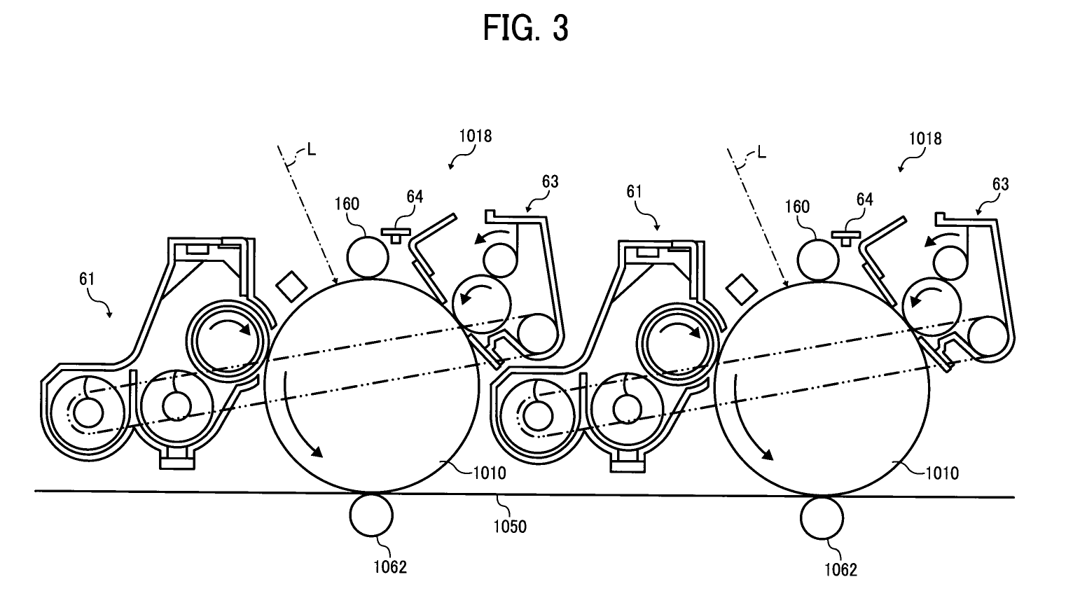

Each image information of black, yellow, magenta and cyan in the tandem type development unit 120 is relayed to each image formation device 1018 (image formation device for black, image formation device for yellow, image formation device for magenta and image formation device for cyan) and each toner image of black, yellow, magenta and cyan is formed by each image formation device. Each image formation device 1018 (image formation device for black, image formation device for yellow, image formation device for magenta and image formation device for cyan) in the tandem type image forming apparatus irradiates the corresponding latent electrostatic image bearing members 1010 (latent electrostatic image bearing member 1010K for black, latent electrostatic image bearing member 1010Y for yellow, latent electrostatic image bearing member 1010M for magenta and latent electrostatic image bearing member 1010C for cyan) with light L (illustrated in FIG. 3), and uniformly charges the charging device 160 which uniformly charges the latent electrostatic image bearing member 1010, an irradiating device to irradiate the latent electrostatic image bearing member 1010 with light to form a latent electrostatic image on the latent electrostatic image bearing member 1010 corresponding to each color image information, a development device 61 which develops the latent electrostatic image with each color toner (black toner, yellow toner, magenta toner, and cyan toner) to form each color toner image, a transfer charging device 1062 to transfer the toner image to the intermediate transfer body 1050, a cleaning device 63 and a discharging device 64. Each single color toner image (black image, yellow image, magenta image and cyan image) can be formed according to corresponding color image information. The thus formed black image, yellow image, magenta image and cyan image on the latent electrostatic image bearing member 1010K, the latent electrostatic image bearing member 1010Y, the latent electrostatic image bearing member 1010M, and the latent electrostatic image bearing member 1010C, respectively, are sequentially transferred (primarily transferred) to the intermediate transfer body 1050 rotationally driven by the supporting rollers 1014, 1015 and 1016. The black image, the yellow image, the magenta image and the cyan image are overlapped on the intermediate transfer body 1050 to obtain a synthesized color image (color transfer image).

One of paper feeder rollers 142 in the paper feeder table 200 is selectively rotated to feed sheets (recording medium) from one of banked paper feeder cassettes 144 and then a separation roller 145 separates sheets one by one and sends it out to a paper feeding path 146. The sheet is guided to a paper feeding path 148 in the main body 150 and stuck at the registration rollers 1049. The registration rollers 1049 are grounded in general but can be used with a bias applied to remove paper dust of a sheet. The registration rollers 1049 are rotated in synchronization with the synthesized color image (transferred color image) and set out the sheet (recording medium) between the intermediate transfer body 1050 and the secondary transfer device 1022. The secondary transfer device 1022 (secondarily) transfers the synthesized color image (transferred color image) to the sheet (recording medium). The toner remaining on the intermediate transfer body 1050 after image transfer is removed by an intermediate transfer body cleaning device 1017.

The sheet (recording medium) to which the color image has been transferred is moved to the fixing device 1025 by the secondary transfer device 1022. The synthesized color image (transferred color image) is fixed on the sheet (recording medium) upon application of heat and pressure by the fixing device 1025. Thereafter, the sheet (recording medium) is discharged to and stuck on a discharging tray 1057 by discharging rollers 1056 by way of a switching claw 1055 or reversed by the sheet reverse device 1028 by way of the switching claw 1055, guided back to the transfer point followed by image formation on the reverse side, and discharged to and stuck on the discharging tray 1057 by the discharging roller 1056.

Having generally described preferred embodiments of this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

The present invention is more described in detail with reference to Examples but is not limited thereto.

### Example 1

### Manufacturing of Oil Phase A

Ingredients of Oil Phase A, low molecule polyester, master batch (MB), Ketimine compound were obtained as follows. Manufacturing of low molecule Polyester (1)

229 parts of an adduct of bisphenol A with 2 mol of ethylene oxide, 529 parts of an adduct of bisphenol A with 3 mol of propylene oxide, 208 parts of terephthalic acid, 46 parts of adipic acid and 2 parts of dibutyloxostannane were placed in a reaction container equipped with a condenser, a stirrer and a nitrogen introduction tube to conduct a polycondensation reaction at 230° C. for 8 hours under normal pressure. Next, the reaction was continued for 5 hours with a reduced pressure of 10 to 15 mmHg. After that 44 parts of trimellitic anhydride was placed in the reaction container and reaction thereof was conducted at 180° C. for 2 hours under normal pressure to obtain [low molecule Polyester 1]. The weight average particle diameter of the low molecule Polyester (1) of the obtained low molecule Polyester (1) was 6,700, the acid value thereof was 25 KOHmg/g and the glass transition temperature thereof was 43° C.

### Synthesis of Master Batch

1,200 parts of water, 540 parts of carbon black (Printex35®, manufactured by Degussa, amount of oil absorption was 42 ml/100 mg, PH was 9.5) and 1,200 parts of polyester resin were mixed by a HENSCEL mixer (manufactured by Mitsui Mining Company, Limited) and kneaded by a two-roll at 150° C. for 30 minutes followed by rolling and cooling. Thereafter, the kneaded mixture was pulverized by a pulverizer to obtain [Master batch 1]. [Master batch 2] was obtained in the same manner as in [Master batch 1] except that carbon black was changed to PY155 (manufactured by Clariant Company, Limited).

### Manufacturing Example of Ketimine Compound

170 parts of isophorone diamine and 75 parts of methylethyl ketone were placed in a reaction container equipped with a stirrer and a thermometer and reaction thereof was conducted at 50° C. for 5 hours to obtain [Ketimine compound 1]. The amine number of [Ketimine compound 1] was 418.

Oil Phase A was obtained as follows.
Manufacturing Example of Black toner

378 parts of [low molecule Polyester 1], 110 parts of carnauba wax, 22 parts of charge control agent (E-84, metal complex of salicylic acid, manufactured by Orient Chemical Industries, Ltd.) and 947 parts of ethyl acetate were mixed and stirred at 80° C. for 5 hours followed by cooling down to 30 ° C. in 1 hour. 500 parts of [Master batch 1] and 500 parts of ethyl acetate were added in the container and mixed for 1 hour to obtain [Solution of Components 1]. 1,324 parts of [Solution of Components 1] were moved to another container and mixed by a bead mill (Ultravisco Mill, manufactured by Imex Co. Ltd.,) using zirconia beads having 0.5 mm of diameter in another container. The zirconia beads were contained 80 volume % of a Bessel capacity of bead mill. A flow rate for circulation of liquid was 1 Kg/hr, a peripheral speed degree of disk (a peripheral speed degree of wing for agitation of beads) was 6 m/s during the mixing process. The mixing process of carbon black and wax was repeated 3 times. After that, 1324 parts of 65 weight % ethyl acetate solution of low molecule Polyester (1) was added, a mixing process having the same condition for mixing was repeated once more to obtain [Colorant and Wax Dispersions (1)] . The solid density of [Colorant and Wax Dispersions (1)] was 50 weight % after dried under 130° C. for 30 minutes. 749 parts of [Colorant and Wax Dispersions (1)] and 2.9 parts of Ketimine Compound were placed in a container and mixed by a Homo Disper (manufactured by PRIMIX) with 5,000 rpm for 1 minute to obtain a black toner. Oil Phase B was obtained as follows.

682 parts of an adduct of bisphenol A with 2 mol of ethylene oxide, 81 parts of an adduct of bisphenol A with 2 mol of propylene oxide, 283 parts of terephthalic acid, 22 parts of trimellitic anhydride and 2 parts of dibutyloxostannane were placed in a reaction container equipped with a condenser, a stirrer and a nitrogen introduction tube to conduct a polycondensation reaction at 230° C. for 8 hours under normal pressure. Next, the reaction was continued for 5 hours with a reduced pressure of 10 to 15 mmHg to obtain [Prepolymer of Polyester 1]. The number-average molecular weight of the [Prepolymer of Polyester 1] was 2,100, the weight average particle diameter was 9,500, the glass transition temperature thereof was 55° C., the acid value thereof was 0.5 KOHmg/g and the hydroxyl value thereof was 51 KOHmg/g.

410 parts of [Prepolymer of Polyester 1], 89 parts of isophorone diisocyanate and 500 parts of ethyl acetate were placed in a reaction container equipped with a condenser, a stirrer and a nitrogen introduction tube to conduct a polycondensation reaction at 100° C. for 5 hours and thus [Prepolymer (1)] having a free isocyanate group was obtained. The content of the free isocyanate group was 1.53 weight %.

### Preparation of Aqueous Phase

Next, an aqueous phase was prepared as follows:

The following components were placed in a container equipped with a stirrer and a thermometer and agitated at 400 rpm for 15 minutes to obtain a white emulsion.

| | | |
|---|---|---|
| Water | 683 | parts |
| Sodium salt of sulfate of an adduct of | 11 | parts |
| methacrylic acid with ethyleneoxide | | |
| (EREMINOR RS-30 from Sanyo | | |
| Chemical Industries Ltd.) | | |
| Styrene | 83 | parts |
| Methacrylic acid | 83 | parts |
| Butylacrylate | 110 | parts |
| Ammonium persulfate | 1 | part |

Thereafter, the emulsion was heated to 75° C. to conduct a reaction for 5 hours. Then, 30 parts of a 1 weight % aqueous solution of ammonium persulfate were added to the emulsion and the mixture was further maturated at 75° C. for 5 hours to prepare an aqueous liquid dispersion [Particulate liquid dispersion 1] of a vinyl resin particles (copolymer of styrene-methacrylic acid-butyl acrylate-sodium salt of sulfate of an adduct of methacrylic acid with ethyleneoxide). The volume average particle diameter (Dv) of organic resin particulates contained in the obtained organic resin particulate liquid dispersion measured by a particle size distribution measuring device (LA-920, manufactured by HORIBA) was 105 nm. A portion of [Particulate liquid dispersion 1] was dried and the resin component was isolated. The glass transition temperature thereof was 59° C. and the weight average particle diameter thereof was 150,000. Subsequently, 83 parts of [Particulate liquid dispersion 1], 990 parts of water, 37 parts of a 48.5% aqueous solution of sodium dodecyldiphenylether disulfonate (EREMINOR MON-7, manufactured by Sanyo Chemical Industries, Ltd.), and 90 parts of ethyl acetate were mixed and stirred and a milk white liquid (Aqueous phase 1) was obtained.

### An Emulsification Process

60.4 parts of the Oil Phase A, 7.4 parts of the Oil Phase B and 101.6 parts of the aqueous Phase 1 were emulsified. An emulsification condition was as follows.

### (1) A Condition of Process at the Beginning of Manufacturing

The condition was decided from a glass transition temperature, molecular weight, acid value and a half efflux temperature as properties of low molecule Polyester.

An approximation type for prediction was analyzed with MT system (the Mahalanobis—Taguchi System) using data for 20 past lot.

Peripheral speed of emulsifier: 16.4 m/s

O/W ratio: 36/64

Quantity for feedings(total amount of the oil phase as well as the aqueous phase): 13 kg/min

Target volume average particle diameter: 5.8 μm

Allowable difference between the volume average particle diameter of the dispersion emulsion measured during the measuring, and a target volume average particle diameter: −0.5 to 0.5 μm

The allowable difference was calculated by the following expression.

Allowable difference=Volume average particle diameter of the dispersion emulsion measured during the measuring−Target volume average particle diameter

### (2) Process Control Instructions

Facilities were automatically driven during controlling process. Facilities including an automatic measurement process for measuring particle diameter of an emulsification particle and a controlling process of particle diameter using a computer were used. In a control process, a flowmeter was introduced on a line for flowing liquid includes materials of toner and PID control with inverter was introduced. And also PID control was introduced for an emulsifier so that number of rotationscan be controlled.

When measured particle diameter is not within the range of an allowable difference between the volume average particle diameter of the dispersion emulsion measured during the measuring, and a target volume average particle diameter, O/W ratio or peripheral speed of emulsifier was controlled, so that measured particle diameter is within the allowable difference.

### (3) Function for Sampling Product

Function for sampling product depending on volume average particle diameter was used so that toner satisfied the targeted volume average particle diameter may be collected.

By performing the process from (1) to (3), time for abandoning product in early period of production (time for abandoning) was 10 min in total production process time of 1000 min, so product were collected for 990 min. Yield of produced product was calculated 99% by the following expression. In addition, the process for work was controllable by one person. Yield of product (%)=Sampling time of Process (min)/Time for total production process (min)

Each emulsification dispersion produced with conditions mentioned above provided a toner by treating as follows.

A de-solvent may be performed with the condition as follows. The emulsified liquid was heated up to 45° C. and the organic solvent was removed at a stirring blade circumferential speed of 10.5 m/s and under the atmosphere pressure (101.3 kPa). It takes 20 hours for solvent removal. After solvent removal, mother toner particles of example 1 were obtained by filtering, washing and drying of the emulsified liquid. Then 100 parts of the obtained mother particle of toner and 0.25 parts of charge controlling agent (BONTRON® E-84, manufactured by Orient Chemical Industries Co., Ltd.) were placed into a Q type mixer (manufactured by Mitsui Mining Company, Ltd.) were mixed by conducting 5 cycles of 2 minute-operation followed by 1 minute-suspend so that total time for treating was 10 minutes, with the circumferential speed of a turbine type blade set at 50 m/sec. Next 0.5 parts of hydrophobic silica (H2000, manufactured by Clariant) was added and 5 cycles of 30 second-mixing followed by 1 minute-suspend were conducted, with the circumferential speed of the blade set at 15 m/sec. In addition, 0.5 parts of hydrophobic silica and 0.5 parts of hydrophobic titanium oxide were mixed by HENSCHEL MIXER. The thus prepared mixed particles were passed through a sieve having an opening not of 37 μm to remove coarse particles and aggregated particles and a black toner and a yellow toner were obtained.

### Example 2

(1) A condition of process at the beginning of manufacturing

The condition was decided from a hydroxyl value and a glass transition temperature as properties of low molecule Polyester.

Circumferential speed of emulsifier: 17.4 m/s

O/W ratio: 37/64

Quantity for feedings: 15 kg/min

Target volume average particle diameter: 5.8 μm

Allowable difference between the volume average particle diameter of the dispersion emulsion measured during the measuring, and a target volume average particle diameter: −0.5 to 0.5 μm

### (2) Process Control Instructions

Facilities were automatically driven during controlling process.

When measured particle diameter is not within the range of an allowable difference between the volume average particle diameter of the dispersion emulsion measured during the measuring, and a target volume average particle diameter, O/W ratio or peripheral speed of emulsifier was controlled, so that measured particle diameter is within the allowable difference.

### (3) Function for Sampling Product

Function for sampling product depending on volume average particle diameter was used so that toner satisfied the targeted volume average particle diameter may be collected.

By performing the process from (1) to (3), time for abandoning product in early period of production (time for abandoning) was 30 min in total production process time of 1000 min, so product were collected for 970 min. Yield of produced product was calculated 97% by the same expression as mentioned above.

In addition, the process for work was controllable by two persons.

### Example 3

### (1) A Condition of Process at the Beginning of Manufacturing

The condition was decided from a glass transition temperature and a NCO group as properties of low molecule Polyester.

Circumferential speed of emulsifier: 16.4 m/s

O/W ratio: 36/64

Quantity for feedings: 13 kg/min

Target volume average particle diameter: 5.8 μm

Allowable difference between the volume average particle diameter of the dispersion emulsion measured during the measuring, and a target volume average particle diameter: −0.5 to 0.5 μm

### (2) Process Control Instructions

Facilities were automatically driven during controlling process.

When measured particle diameter is not within the range of an allowable difference between the volume average particle diameter of the dispersion emulsion measured during the measuring, and a target volume average particle diameter, O/W ratio or peripheral speed of emulsifier was controlled, so that measured particle diameter is within the allowable difference.

### (3) Function for Sampling Product

Function for sampling product depending on volume average particle diameter was used so that toner satisfied the targeted volume average particle diameter may be collected.

By performing the process from (1) to (3), time for abandoning product in early period of production (time for abandoning) was 30 min in total production process time of 1000 min, so product were collected for 970 min. Yield of produced product was calculated 97% by the same expression as mentioned above. In addition, the process for work was controllable by two persons.

### Comparative Example 1

### (1) A Condition of Process at the Beginning of Manufacturing

The condition was same as the condition for the end of the previous production.

Circumferential speed of emulsifier: 16.4 m/s

O/W ratio: 35/64

Quantity for feedings: 18 kg/min

Target volume average particle diameter: 5.8 μm

Allowable difference between the volume average particle diameter of the dispersion emulsion measured during the measuring, and a target volume average particle diameter: −0.5 to 0.5 μm

### (2) Process Control Instructions

Controlling particle diameter was driven by a human operator.

When measured particle diameter is not within the range of an allowable difference between the volume average particle diameter of the dispersion emulsion measured during the measuring, and a target volume average particle diameter, O/W ratio or peripheral speed of emulsifier was controlled by a human operator, so that measured particle diameter is within the allowable difference.

### (3) Function for Sampling Product

Sampling of product was done by a human operator.

By performing the process from (1) to (3), time for abandoning product in early period of production (time for abandoning) was 50 min in total production process time of 1000 min, so product were collected for 950 min. Yield of produced product was calculated 95% by the same expression as mentioned above. In addition, the process for work was controllable by three persons.

### [Picture Evaluation; Evaluation of the Thin-Line Reproducibility]

The toner of Example 1 was evaluated for thin-line reproducibility using a modified intermediate transfer type-commercial color copier (Imagio color 5000: made by Ricoh) in which the fixing oil unit was removed. The evaluation was carried out by printing on 6,000 paper sheets (made by Ricoh) at an image coverage of 7% each. Thin lines of the tenth image and those of 30,000th image in the running operation were compared using an optical microscope at 100× magnification for the loss of lines while referring to a scale sample; the status of thin lines was ranked in 5 grades (1-5), with 5 showing the best condition. The evaluation ranks of 3.5 or greater were levels without problems.

TABLE 1

| | Process | | |
|---|---|---|---|
| | condition at | | |
| | the beginning | Process control | Product sampling |
| | of a production | instructions | function |
| Example 1 | Equation | Automatically | Automatically |
| Example 2 | Equation | Automatically | Automatically |
| Example 3 | Equation | Automatically | Automatically |
| Comparative | The condition | By human | By human operator |
| Example 1 | that went on | operator | |
| | the day before | | |
| | was adopted | | |

TABLE 2

| | | arithmetic | |
|---|---|---|---|
| | Equation of (1) | function | Yield(%) |
| Example 1 | Tg, AV | Used | 99 |
| Example 2 | hydroxyl value, | Unused | 97 |
| | Tg | | |
| Example 3 | NCO basis, Tg | Unused | 97 |
| Comparative | Unused | Unused | 95 |
| Example 1 | | | |

TABLE3

| | | |
|---|---|---|
| Number of | | |
| worker for | Granularity | Picture |

| | production | Dv | Dv/Dn | evaluation |
|---|---|---|---|---|
| Example 1 | 1 | 5.8 | 1.12 | 5 |
| Example 2 | 2 | 5.8 | 1.12 | 5 |
| Example 3 | 2 | 5.7 | 1.16 | 3 |
| Comparative | 3 | 5.8 | 1.19 | 3 |
| Example 1 | | | | |

Tg: glass transition temperature
AV: acid value
NCO basis: isocyanate group

This document claims priority and contains subject matter related to Japanese Patent Application No. 2008-132079, filed on May 20, 2008, the entire contents of which are incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patanet of the United States is:

1. A method of manufacturing a toner comprising:
a first dispersing wherein (i) at least two binder resins having different weight average molecular weight, (ii) a coloring agent and (iii) a releasing agent are dispersed in an organic solvent to obtain an oil phase;
a second dispersing comprising continuously mixing the oil phase with an aqueous medium comprising a solid particulate dispersion agent to form a dispersion emulsion comprising emulsification particles;
wherein the at least one of the first and the second dispersing is carried out under at least one condition based on a property of the binder resin which has the lowest weight-average molecular weight;
measuring automatically the volume average particle diameter of the dispersion emulsion during the second dispersing;
calculating automatically a difference between the volume average particle diameter of the dispersion emulsion measured during the measuring, and a target volume average particle diameter;
maintaining automatically an allowable difference between the volume average particle diameter of the dispersion emulsion measured during the measuring, and a target volume average particle diameter, by changing one of the conditions.

2. The method of manufacturing a toner according to claim 1,
wherein at least one of the property of the binder resin which has the lowest weight-average molecular weight among the resins for toner is selected from the group comprising of the glass transition temperature (Tg) of the resin, the weight-average molecular weight of the resin, the acid value of the resin and the half efflux temperature of the resin.

3. The method of manufacturing a toner according to claim 1,
wherein at least one of the condition is selected from the group comprising of a circumferential speed of a emulsification machine, a ratio of the oil phase and the aqueous phase (O/W ratio) and a total amount of the oil phase as well as the aqueous phase.

4. The method of manufacturing a toner according to claim 1,
further comprising collecting the emulsification particles that are within −0.5 to 0.5 μm range of the target particle diameter.

5. An apparatus of manufacturing a toner, comprising:
an emulsifying facility for continuously emulsifying a dispersion of at least two binder resins having different weight-average molecular weight, a coloring agent and a releasing agent in an organic solvent (oil phase) in an aqueous medium includes a solid particulate dispersion agent;
wherein the emulsifying facility comprising a means for dispersing under a condition based on at least one property of the binder resin which has the lowest weight-average molecular weight;
a means for automatically measuring the volume particle diameter of the dispersion emulsion during the dispersing;
a means for calculating a difference between the volume average particle diameter of the dispersion emulsion measured during the measuring, and a target volume average particle diameter;
a means for receiving a signal for controlling the process of manufacturing;
wherein the signal is calculated from a relation between the information about the difference between the volume average particle diameter of the dispersion emulsion measured during the measuring, and a target volume average particle diameter calculated by the means for calculating and a difference between a volume average particle diameter of a dispersion emulsion measured during the measuring, and a target volume average particle diameter as well as a condition for process inputted in the computer beforehand;
a means for automatically controlling the process of manufacturing;
a means for collecting the emulsification particles that satisfy the required volume average particle diameter.

6. A toner that is manufactured according to the method of claim 1,
wherein the toner has a volume average particle diameter is from 3 to 10 μm.

7. The toner according to claim 6,
wherein the toner has a ratio (Dv/Dn) of a volume average particle diameter (Dv) to a number average particle diameter (Dn) from 1.05 to 1.25.

8. An image forming method, comprising:
forming a latent image on an image bearing member;
developing the latent image with a developer comprising the toner according to claim 6 to form a toner image;
transferring the toner image onto a transfer material; and
fixing the toner image on the transfer material upon application of heat.

9. An image forming apparatus, comprising:
an image bearing member bearing an electrostatic latent image;
an image developer developing the latent image with a developer comprising the toner according to claim 6 to form a toner image on the image bearing member; and
a container containing the developer.
